(19) United States
(12) Patent Application Publication
(10) Pub. No.: US 2013/0202789 A1
(43) Pub. Date: Aug. 8, 2013

(54) METHODS OF ACETYLATION OF WOOD INVOLVING MULTIPLE ACETYLATION CYCLES

(71) Applicant: Eastman Chemical Company, Kingsport, TN (US)

(72) Inventors: Eleanor Hawkins Cwirko, Kingsport, TN (US); Timothy Lee Guinn, Bluff City, TN (US); Christopher George Garrett, Kingsport, TN (US); Charles Howard Foster, Kingsport, TN (US)

(73) Assignee: Eastman Chemical Company, Kingsport, TN (US)

(21) Appl. No.: 13/761,834

(22) Filed: Feb. 7, 2013

Related U.S. Application Data
(60) Provisional application No. 61/596,463, filed on Feb. 8, 2012.

(51) Int. Cl. B27K 3/02

(52) U.S. Cl. CPC B27K 3/02
USPC 427/212

(57) ABSTRACT

This invention relates to acetylation of wood. In particular, the invention provides methods of acetylation of solid wood in which at least some of the solid wood is processed in multiple acetylation cycles. The invention further provides wood acetylation methods that include sorting solid wood pieces based on density-indicating parameters.

### CROSS REFERENCE TO RELATED APPLICATIONS

This application claims priority to U.S. Provisional Application No. 61/596,463, filed Feb. 8, 2012, the disclosure of which is incorporated herein by reference in its entirety, provided that in the event of any conflict between definitions in the prior application and those in this application, the definitions in this application shall control.

### FIELD OF THE INVENTION

This invention relates to acetylation of wood. In particular, the invention provides methods of acetylation of solid wood in which at least some of the solid wood is processed in multiple acetylation cycles.

### BACKGROUND OF THE INVENTION

Acetylated wood is useful in many applications because it has greater dimensional stability than untreated wood and because of other favorable qualities. As a natural material, wood varies significantly in properties, both between species and, in some cases, within species. Density is one such property. Depending on the desired degree of acetylation and other properties of the wood, denser material can be more difficult to acetylate. There is a continuing need for acetylation processes that provide a desirably high degree of acetylation and consistency in the degree of acetylation in a given batch of material. It is therefore desirable to develop acetylation processes having the flexibility to acetylate wood over a variety of densities efficiently and effectively.

### BRIEF SUMMARY OF THE INVENTION

The invention thus provides processes for producing acetylated solid wood, the process including: (a) determining a threshold value for a density-indicating parameter for a plurality of solid wood pieces; (b) measuring an actual value for the density-indicating parameter for at least some of the solid wood pieces; (c) identifying a low-density group of the solid wood pieces and a high-density group of the solid wood pieces based on the threshold value and the measured actual values for the density-indicating parameters; (d) subjecting at least a first majority selected from the high-density group of the solid wood pieces to at least one more acetylation cycle than at least a second majority selected from the low density group of the solid wood pieces.

In some embodiments identifying the low-density group and the high-density group includes assigning to the high density group all boards for which the measured density-indicating parameter indicates a density that is greater than that indicated by the threshold value, and assigning to the low density group all boards for which the measured density-indicating parameter indicates a density that is less than or equal to that indicated by the threshold value. In some embodiments, identifying the low-density group and the high-density group includes assigning to the high density group all boards for which the measured density-indicating parameter indicates a density that is greater than or equal to that indicated by the threshold value, and assigning to the low density group all boards for which the measured density-indicating parameter indicates a density that is less than that indicated by the threshold value.

In some embodiments, the threshold value and actual values for density-indicating parameter measurements indicate dry density. In some embodiments, the actual values for the density-indicating parameter measurements indicate wet density, the method further includes identifying water content of the at least some pieces, and the threshold value is a wet density value that, based on the identified water content, corresponds to a selected dry density value.

In some embodiments, at least one of the acetylation cycles for the high-density group is less robust than at least one of the acetylation cycles for the low-density group. In some embodiments, at least one of the acetylation cycles for the high-density group is less robust than all of the acetylation cycles for the low-density group. In some embodiments, all of the acetylation cycles for the high-density group are less robust than all of the acetylation cycles for the low-density group. In some embodiments, at least one of the acetylation cycles for the high-density group is less robust than at least one of the other acetylation cycles for the high-density group. In some embodiments, the sequentially final acetylation cycle for the high-density group is more robust than at least one other acetylation cycle for the high-density group.

In some embodiments, measuring an actual value for the density-indicating parameter includes measuring actual density. In some embodiments, wherein measuring an actual value for the density-indicating parameter includes measuring a mass value that determines density based on the dimensions of solid wood pieces. In some embodiments, the threshold value is a value that indicates a density between about 0.52 and about 0.63 g/cc. In some embodiments, the threshold value is a value that indicates a density that corresponds to a dry density of 0.57 g/cc on a 95/5 impregnant and 6% wood water basis.

In some embodiments, at least the first majority of the solid wood pieces in the high density group are subjected to two acetylation cycles and at least the second majority of the solid wood pieces in the low density group are subjected to one acetylation cycle. In some embodiments, the first majority includes a majority of the total number of pieces in the high-density group and the second majority includes of the total number of solid wood pieces in the low-density group. In some embodiments, the first majority includes at least about 90% of the total number of solid wood pieces in the high-density group the second majority includes at least about 90% of the total number of the solid wood pieces in the low-density group. In some embodiments, the first majority includes all solid wood pieces of the high-density group and the second majority includes all solid wood pieces of the low-density group. In some embodiments, the process includes further screening and removal of solid wood pieces based on nonconformity with a specification and the first majority is a majority of the on-specification solid wood pieces of the high density group and the second majority is a majority of the on-specification solid wood pieces of the low-density group. In some embodiments, the first majority includes at least about 90% of the on-specification solid wood pieces in the high-density group the second majority includes at least about 90% of the on-specification solid wood pieces in the low-density group. In some embodiments, the first majority includes all on-specification solid wood pieces of the high-density group and the second majority includes all the on-specification solid wood pieces of the low-density group.

The invention further provides processes for producing acetylated solid wood in which the process includes acetylating solid wood using two or more acetylation cycles to thereby produce acetylated wood, wherein at least one of the two or more acetylation cycles is less robust than at least one other of the two or more acetylation cycles, at least one of the two or more acetylation cycles includes an impregnation step that is less robust than the impregnation step at least one other of the two or more acetylation cycles, or both of the foregoing. In some embodiments, at least one of the two or more acetylation cycles is less robust than at least one other of the two or more acetylation cycles. In some embodiments, the sequentially first acetylation cycle is less robust than at least one other acetylation cycle. In some embodiments, the sequentially last acetylation cycle is more robust than at least one other acetylation cycle. In some embodiments, the sequentially first acetylation cycle is more robust than at least one other acetylation cycle. In some embodiments, the sequentially last acetylation cycle is less robust than at least one other acetylation cycle. In some embodiments, the total number of acetylation cycles in the process is two.

In some embodiments, at least one of the two or more acetylation cycles includes an impregnation step that is less robust than the impregnation step of at least one other of the two or more acetylation cycles. In some embodiments, the less robust impregnation step has a mass uptake of impregnating fluid that is from about 0.05 to about 0.50 fewer grams of impregnating fluid per gram of wood than the mass uptake of impregnating fluid of the more robust cycles

In some embodiments, the total mass uptake of impregnating fluid of all impregnation steps in the process is from about 0.80 to about 2.00 grams of impregnating fluid per gram of wood.

Each of the above processes may be used with any species or combinations of species of wood. In some embodiments, the wood is Southern Yellow Pine.

### BRIEF DESCRIPTION OF THE DRAWINGS

FIG. 1 is a graph showing the percent bound acetyls at different pre-acetylation densities for boards that were not sorted based on density prior to acetylation. The x-axis represents density measured prior to acetylation and the y-axis represents percent bound acetyls. Data points are presented as triangles.

FIG. 2 is a graph showing the percent bound acetyls at different pre-acetylation densities for boards that were sorted based on density prior to acetylation. Boards having a density of less than or equal to 0.57 grams per cubic centimeters were placed in a low-density group and acetylated once. Boards having a density of greater than 0.57 grams per cubic centimeters were placed in a high-density group and acetylated twice. Diamond-shaped datapoints represent boards in the low-density group that were subjected to a single acetylation cycle. Round datapoints represent boards in the high-density group that were subjected to two acetylation cycles. The x-axis and y-axis are the same as in FIG. 1.

FIG. 3 is a graph presents the data from FIG. and FIG. 2 together. The x-axis and y-axis are the same as in FIG. 1 and the data points are indicated by the same symbols as in FIG. 1 and FIG. 2.

### DETAILED DESCRIPTION

The invention provides a number of methods for acetylating a group of solid wood pieces, wherein at least some of the solid wood pieces are subjected to two or more acetylation cycles. In some embodiments, higher-density pieces are subjected to one or more additional acetylation cycles than lower-density pieces. An example is a process in which lower-density pieces are subjected to a single acetylation cycle while higher-density pieces are subject to two or more acetylation cycles. In some embodiments, both high and low density pieces are subjected to multiple cycles, but higher-density pieces are subjected to at least one more acetylation cycles than lower-density pieces. Unless specifically indicated, all references to “density” throughout this application refer to density on a dry basis, i.e. calculated excluding the mass of any water in the wood. Thus the invention provides acetylation methods involving multiple acetylation cycles. The invention further provides methods for sorting individual pieces into groups, and subjecting the different groups to differing amounts of acetylation cycles.

The invention further provides methods involving two or more acetylation cycles to produce acetylated wood in which at least one of the cycles is less robust than at least one other of the acetylation cycles. The use of multiple cycles can create inefficiency concerns due to the use of twice as much impregnating material, heating or reactor time. However, it has been found in multiple acetylation embodiments that desirable levels of acetylation can be achieved efficiently even in higher density wood even if one of the cycles is less robust than the other.

### Solid Wood

The invention relates to methods of acetylating solid wood. As used throughout this application, “solid wood” shall refer to pieces of wood that measure at least about ten centimeters in at least one dimension but are otherwise of any dimension, e.g. lumber having nominal dimensions such as 2 inches×2 inches by four inches, ×2 inches×2 inches by 6 inches, 1 inch×1 inch by 6 inches, 2 feet×2 feet by 4 feet, 2 feet×2 feet by 6 feet 1 foot×1 foot by 6 feet, one inch by six inches by eight feet, one inch by six inches by twelve feet, one inch by six inches by sixteen feet, two inches by four inches by sixteen feet, two inches by four inches by 12 feet, two inches by four inches by eight feet, etc., as well as objects machined from cut lumber (e.g. molding, spindles, balusters, etc.). Some examples include lumber, boards, veneers, planks, squared timber, beams or profiles. In some embodiments, the solid wood is dimensional lumber. Solid wood of any dimension may be used. In some embodiments, the solid wood measures at least about ten centimeters in at least one dimension and at least about 5 millimeters in another dimension. The longest dimension can measure, for example, about three feet, about four feet, about six feet, about eight feet, about ten feet, about twelve feet, about 14 feet, about 16 feet, etc.

The longest dimension can also be described as being at least or greater than or equal to any of the foregoing values (e.g. at least about three feet, at least about four feet, greater than or equal to about 12 feet, etc.). A second dimension of the wood may be the second longest dimension or may be equal to the longest dimension. Some examples of the second longest dimension include about 1/10 inch, about ⅛ inch, about ⅙ inch, about ¼ inch, about ⅓ inch, about ⅜ inch, about 0.5 inch, about ⅝ inch, about 0.75 inches, about one inch, about 1.5 inches, about two inches, about three inches, about four inches, about five inches, about six inches, about eight inches, about nine inches, about ten inches, about 12 inches, about 14 inches, about 16 inches, about 18 inches, about 20 inches, about 24 inches, about three feet, about four feet, etc. The second longest dimension can also be described as being at least or greater than or equal to any of the foregoing values (e.g. at least about 1/10 inch, greater than or equal to about 0.5 inch, at least about 0.75 inch, etc., at least about 1 inch, at least about 1.5 inches, at least about two inches, at least about four inches, at least about five inches, etc.). The third dimension can be the same as or different from the second dimension and can be, for example any of the values described above for the second dimension. In some embodiments, the wood measures the same length in all three dimensions. In some embodiments, the solid wood measures at least about 30 inches in its longest dimension and at least about 0.25 inch in two other dimensions. In some embodiments, the solid wood measures at least about 30 inches in its longest dimension and at least about 0.5 inch in two other dimensions. In some embodiments, the solid wood measures at least about 30 inches in its longest dimension and at least about 0.75 inch in two other dimensions. In some embodiments, the solid wood measures at least about 36 inches in its longest dimension and at least about 0.5 inch in two other dimensions. In some embodiments, the solid wood measures at least about 48 inches in its longest dimension and at least about 0.75 inch in two other dimensions. In some embodiments, the solid wood measures at least about 30 inches in at least one dimension, at least about 1.5 inches in another dimension and at least about 0.5 inch in a third dimension. In some embodiments, the solid wood measures at least about four feet in at least one dimension, at least about 1.5 inches in another dimension and at least about 0.5 inch in a third dimension. In some embodiments, the solid wood measures at least about eight feet in its longest dimension, at least about five inches in another dimension and at least about one inch in a third dimension.

The foregoing dimensions can also be expressed as ranges. For example, the longest dimension can also be described as being from about four feet to about 20 feet, from about three feet to about 20 feet, from about 30 inches to about 20 feet, from about four feet to about 18 feet, from about four feet to about 15 feet, from about 30 inches feet to about 15 feet, etc. Some example ranges for the second longest dimension include from about 1/10 inch to about six feet, from about ⅛ inch to about six feet, from about ⅙ inch to about six feet, from about ¼ inch to about six feet, from about ⅓ inch to about six feet, from about ⅜ inch to about six feet, from about 0.5 inch to about six feet, from about 0.5 inch to about four feet, from about 0.5 inch to about two feet, from about 0.5 inch to about 12 inches, from about one inch to about four feet, from about two inches to about four feet, from about four inches to about four feet, from about one foot to about six feet, from about one foot to about four feet, from about one 0.5 inch to about one foot, from about one inch to about two feet, from about one inch to about one foot, from about 0.5 inch to about 18 inches etc. The third dimension can be the same as or different from the second dimension. Some examples ranges for the third longest dimension include each of the ranges described above for the second dimension. Additional examples of ranges for the third dimension include: from about 0.25 inches to about 6 inches, from about 0.25 inches to about 18 inches, from about 0.5 inches to about 18 inches, from about 0.5 inches to about 12 inches, from about 0.75 inches to about 12 inches, and from about 1 inch to about 2 feet. In some embodiments, the solid wood measures from about 30 inches to about 20 feet in its longest dimension about 0.25 inch to about six feet in two other dimensions. In some embodiments, the solid wood measures from about 30 inches to about 20 feet in its longest dimension about 0.5 inch to about six feet in two other dimensions. In some embodiments, the solid wood measures from about four feet to about 18 feet in its longest dimension about 0.5 inch to about 12 inches in two other dimensions. In some embodiments, the solid wood measures from about 36 inches to about 18 feet in its longest dimension and from about 0.5 inches to about six feet in two other dimensions. In some embodiments, the solid wood measures from about four feet to about 18 feet in its longest dimension and from about 0.5 inches to about six feet in two other dimensions. In some embodiments, the solid wood measures from about 30 inches to about 15 feet in its longest dimension and from about 0.75 inches to about 10 inches in two other dimensions. In some embodiments, the solid wood measures from about four feet to about eighteen feet in at least one dimension, from about 1.5 inches to about 10 inches in a second dimension, and from about 0.5 inch to about five inches in a third dimension. In some embodiments, the solid wood measures at from about eight to about 18 feet in its longest dimension, from about five inches to about 15 inches in another dimension and about one inch to about five inches in a third dimension.

By referring to wood that “measures” specific dimensions, it is meant that the stated dimensions are actual measured dimensions and not nominal dimensions. However, these numbers are not limiting and embodiments exist wherein each of the foregoing figures represent nominal dimensions rather than measured dimensions. Unless the word “nominal” is used, stated dimension will be taken to mean actual rather than nominal dimensions. When two or three dimensions are identified, it is meant that each dimension is at about a 90 degree angle to other stated dimensions (for example, about 0.5 inch thickness by 1.5 inches width by about 30 inches length). Combinations of different types of wood having differing dimensions (i.e. two or more of the foregoing dimensions) may also be used.

In some embodiments, one of the dimensions described in the foregoing paragraph is parallel to the direction of the grain of at least some of the solid wood. Thus, any of the measurements above may describe the dimension of the board in the axis of the grain of at least some of the solid wood. In some embodiments, the longest dimension is parallel to the direction of the grain of at least some of the solid wood.

The invention allows acetylation of multiple pieces of solid wood, including solid wood of any of the foregoing dimensions (or combinations thereof), to be esterified at once. In some embodiments, pieces of solid wood are arrayed in vertical stacks of two or more pieces with “spacers” or “stickers” vertically disposed between the pieces in a given stack. Spacers are small rods of material having a selected thickness, and may be of any effective thickness. Some examples include one-eighth to two inches, between one-fourth and 1.5 inches, and between three-eighths and 1 inch. Some example thicknesses of spacers include about ¼ inch, about ⅓ inch, about ⅜ inch, about 0.5 inch, about ⅝ inch, about 0.75 inches, about one inch, about 1.5 inches and about two inches. The foregoing thicknesses may refer to the diameter of the spacer or the longest cross-sectional dimension (i.e. other than length) of the spacer or the spacers may be square or otherwise equilateral in cross-section such that thickness refers to each of the cross-sectional dimensions. Spacers may have any effective cross-sectional shape. Some examples include square, triangle, round, oval, elliptical or polygonal. In some embodiments, the spacers are arrayed such that a two or more layers of solid wood are arrayed between each layer of spacers. In some embodiments, each stack has a thickness of about 0.5 inches, and each stack contains multiple pieces of solid wood each having dimensions less than about 0.5 inches (for example, four pieces of ⅛ inch thick veneer). Embodiments exist in which the thickness of the stacks of wood between spacers is about 0.75 inches, about one inch, about 1.5 inches, about two inches, about three inches, about four inches, about five inches, about six inches, about eight inches, about nine inches, about ten inches, about 12 inches, about 14 inches, about 16 inches, about 8 inches, about 20 inches, about 24 inches, about three feet about four feet, etc. The thicknesses of the wood in the foregoing sentence can reflect single pieces of wood of such thickness or stacks of wood of such thickness, e.g. for example, a single piece of wood about four inches thick or a stack of four pieces of wood that are each about one inch thick. The thicknesses of the stacks of wood can also be described as being at least or greater than or equal to any of the foregoing values (e.g. at least about 0.75 inch greater than or equal to about 1.5 inches, etc.). Thickness of wood stacked between different spacers can also vary within a single stack of wood or between stacks in a multi-stack batch of wood.

The solid wood can contain water prior to acetylation. In some embodiments, the mean water content of the wood is in the range of 0.5-20 weight percent water prior to the first acetylation cycle. Water content will depend in part the wood's source, exposure to elements after harvesting, and any processes performed on the wood to dry it prior to acetylation. For example, embodiments exist for wood having water content in any of the following ranges: from about 0.5 to about 10%; from about 5 to about 15%; from about 10 to about 20%; from about 0.5 to about 5%; from about 5 to about 10%; from about 10 to about 15%; from about 15 to about 20%; from about 0.5 to about 2%; from about 1 to about 3%; from about 2 to about 4%; from about 3 to about 5%; from about 4 to about 6%; from about 5 to about 7%; from about 6 to about 8%; from about 7 to about 9%; from about 8 to about 10%. In some embodiments, the mean water content can be expressed as about 1, about 2, about 3, about 4, about 5, about 6, about 7, about 8, about 9, or about 10%.

Any effective method can be employed to achieve the desired water content of the solid wood prior to esterification. Some examples include kiln drying and/or solvent drying by impregnation with a liquid other than water. Any effective solvent may be used in solvent drying, including, for example, acetic acid, methanol, acetone, methyl isobutyl ketone, xylene and ester solvents (e.g. acetate esters such as isopropyl acetate, n-propyl acetate etc.). These processes may be assisted by applying vacuum, pressurized environments, or both, including cycles of multiple stages of vacuum, pressure, or both. Any effective solvent may be used in solvent drying, including, for example, acetic acid, methanol, acetone, methyl isobutyl ketone, xylene and ester solvents (e.g. acetate esters such as isopropyl acetate, n-propyl acetate etc.).

Wood may be selected from any species of hardwood or softwood. In some embodiments the wood is a softwood. In some embodiments the wood is a hardwood. In some embodiments the wood is selected from pine, fir, spruce, poplar, oak, maple and beech. In some embodiments, the wood is selected from red oak, red maple, red alder, hickory, cherry, German beech, and Pacific albus. In some embodiments, the wood is a pine species. In some embodiments, the pine species is selected from Loblolly Pine, Longleaf Pine, Shortleaf Pine, Slash Pine, Radiata Pine and Scots Pine. In some embodiments, the wood is Radiata Pine. In some embodiments, the wood is Ponderosa Pine. In some embodiments, the wood is from one or more of the four species commercially referred to as “Southern Yellow Pine” (Longleaf Pine, Shortleaf Pine, Slash Pine, Loblolly Pine). In some embodiments, the wood is selected from Longleaf Pine, Shortleaf Pine, and Loblolly Pine. In some embodiments, the wood is Loblolly Pine. Combinations of two or more of any of the foregoing species and groups of species may be used.

In some embodiments, the density in the wood that is processed using these methods is in the range of about 0.30 to about 0.90 grams per cubic centimeter (g/cc) prior to acetylation. In some embodiments, the range is about 0.45 to about 0.80 g/cc, or narrower ranges such as 0.50 to about 0.75 g/cc.

### Acetylation Cycles

As used throughout this application, an “acetylation cycle” refers to a process that includes impregnating wood with a liquid that contains acetic anhydride and heating the impregnated wood under conditions effective to cause an acetylation reaction to occur in at least some of the wood. An acetylation cycle may include additional steps besides the impregnating step and reaction step, and may include either a plurality of impregnation steps or a plurality of reaction steps, but whenever an impregnation step is followed (directly or indirectly) by a reaction step, an acetylation cycle exists. When another impregnation step occurs again after a reaction step, that impregnation step is the beginning of another acetylation cycle.

Any suitable means of impregnation may be used. In some embodiments, impregnation occurs by contacting the solid wood with a liquid containing acetic anhydride, for example by immersing the solid wood in the liquid. In some embodiments, the pressure under which the impregnation occurs is controlled. For example, in some embodiments the solid wood is contacted with the liquid in a vessel in which the pressure has been reduced below atmospheric pressure to draw material (such as gasses) out of spaces within the wood and to allow impregnating liquid to penetrate those spaces when pressure is restored to ambient or otherwise raised. In some embodiments, the solid wood is contacted with the liquid in a vessel in which the pressure has been elevated above atmospheric pressure to force impregnating liquid into the solid wood. Changes in pressure may occur before, during or after contact with the liquid. In some embodiments, pressure is varied during or in connection with impregnation. For example, in some embodiments the solid wood can be placed in a vessel in which vacuum is then created and maintained for a period of time to remove a desired degree of air or other gasses from spaces in the solid wood, then contacted with the impregnating liquid while maintaining vacuum, and then subjected to pressures above atmospheric pressure to force impregnating liquid into the spaces. Multiple steps or cycles of pressurization, vacuum and/or restoration of atmospheric pressure as well as combinations of any or all of these conditions in any order or number of repetition may be used. Pressurization or repressurization may be accomplished by any means, including, but not limited to, adding atmospheric air, adding additional vapors or gasses such as inert gasses (e.g. nitrogen), adding acetic anhydride in liquid or gaseous form, or adding other materials.

The impregnating liquid may contain any effective amount of acetic anhydride. In some embodiments, the liquid contains at least about 50% acetic anhydride by weight. In some embodiments, the liquid contains at least about 60% acetic anhydride by weight. In some embodiments, the liquid contains at least about 75% acetic anhydride by weight. In some embodiments, the liquid contains at least about 80% acetic anhydride by weight. In some embodiments, the liquid contains at least about 85% acetic anhydride by weight. In some embodiments, the liquid contains at least about 90% acetic anhydride by weight. In some embodiments, the liquid contains at least about 95% acetic anhydride by weight. In some embodiments, the liquid contains at least about 99% acetic anhydride by weight. In some embodiments, the vapor has the same percent anhydride content by weight as the liquid that was boiled to produce the vapor. In some embodiments, the vapor contains from about 50% to about 100% acetic anhydride by weight. In some embodiments, the vapor contains acetic anhydride in an amount selected from any of the following ranges: from about 75% to about 100%, from about 85% to 100% by weight, from about 90% and about 100% acetic anhydride by weight. In some embodiments, the impregnating liquid that contains acetic anhydride also contains acetic acid. In some embodiments, the acid is present in a weight percentage that, when added to the acetic anhydride percentage, provides a sum that is within less than 1% of 100%. Some examples include 95% acetic anhydride and 5% acetic acid and 99% acetic anhydride and 1% acetic acid. In some embodiments, the impregnating liquid may contain acetic anhydride and/or acetic acid that has been previously used in or generated as a byproduct of an acetylation process. Such material may or may not contain wood byproduct materials and derivatives thereof. Some examples include tannins and other polyphenolics, coloring matter, terpenes, essential oils, fats, resins, waxes, gum starch, or metabolic intermediates.

Once the impregnating step is complete, at least a portion of the liquid treatment agent, if present, can optionally be drained from the reactor and heat can be added to initiate and/or catalyze the reaction.

The reaction step involves heating the solid wood sufficiently to commence an acetylation reaction in at least some of the solid wood. Heating may involve applying energy or transferring heat by any suitable means including, for example, by contacting wood with a heat transfer agent, application of energy, or a combination of the foregoing. Where the heating includes application of energy, any effective energy may be used. Some examples of energy that can be used include radiant energy or electromagnetic radiation such as radiofrequency, microwave radiation or infrared radiation, solar radiation or any combination of the foregoing. Where the heating includes contacting the wood with a heat transfer medium, any medium may be used. Some examples include steam, heated inert gasses such as nitrogen or air, liquid heat transfer media such as heated oils, and heated vapors of compounds that are reactants or products of acetylation reactions such as acetic acid vapors, acetic anhydride vapors, or any combination of two or more of the foregoing. In some embodiments, heating is accomplished with an inert gas that is at least partially saturated with acetic acid, acetic anhydride or both.

In some embodiments, the heating is accomplished by contacting the solid wood with a vapor that is the result of boiling a composition that contains at least about 50% acetic anhydride by weight. In some embodiments, the vapor is the result of boiling a composition that contains at least about 60% acetic anhydride by weight. In some embodiments, the vapor is the result of boiling a composition that contains at least about 75% acetic anhydride by weight. In some embodiments, the vapor stream is the result of boiling a composition that contains acetic anhydride in a concentration of at least about 80% by weight. In some embodiments, the vapor is the result of boiling a composition that contains at least about 85% acetic anhydride by weight. In some embodiments, the vapor is the result of boiling a composition that contains at least about 90% acetic anhydride by weight. In some embodiments, the vapor is the result of boiling a composition that contains at least about 95% acetic anhydride by weight. In some embodiments, the vapor has the same percent anhydride content by weight as the liquid that was boiled to produce the vapor. In some embodiments, the vapor contains between about 50% and about 100% acetic anhydride by weight. In some embodiments, the vapor contains between about 75% and about 100% acetic anhydride by weight. In some embodiments, the vapor contains between about 85% and about 100% acetic anhydride by weight. In some embodiments, the vapor contains between about 90% and about 100% acetic anhydride by weight. In some embodiments, the vapor contains at least about 98% acetic anhydride by weight. The remainder of composition may be any compound or combination of compounds that does not unduly interfere with the esterification. Thus, in some embodiments, a heated vapor stream is the result of boiling a composition that contains acetic anhydride in one of the percentages above and acetic acid (e.g., about 80:20 anhydride/acid, about 85:15 anhydride/acid, about 90:10 anhydride/acid, or about 95:5 anhydride/acid). Thus, in some embodiments, the vapor has an anhydride/acid ratio in the range from about 50:50 to about 99:1. In some embodiments, the vapor has an anhydride/acid ratio in the range from about 75:25 to about 99:1. In some embodiments, the vapor has an anhydride/acid ratio in the range from about 75:25 to about 95:1. In some embodiments, the vapor has about the same composition by weight as the liquid that was boiled to produce the vapor.

In some embodiments, the vapor is the result of boiling a composition that contains at least about 50% acetic acid by weight. In some embodiments the vapor is the result of boiling a composition that contains at least about 60% acetic acid by weight. In some embodiments, the vapor is the result of boiling a composition that contains at least about 75% acetic acid by weight. In some embodiments, the vapor stream is the result of boiling a composition that contains acetic acid in a concentration of at least about 80% by weight. In some embodiments, the vapor is the result of boiling a composition that contains at least about 85% acetic acid by weight. In some embodiments, the vapor is the result of boiling a composition that contains at least about 90% acetic acid by weight. In some embodiments, the vapor is the result of boiling a composition that contains at least about 95% acetic acid by weight. In some embodiments, the vapor has the same percent acid content by weight as the liquid that was boiled to produce the vapor. In some embodiments, the vapor contains between about 50% and about 100% acetic acid by weight. In some embodiments, the vapor contains between about 75% and about 100% acetic acid by weight. In some embodiments, the vapor contains between about 85% and about 100% acetic acid by weight. In some embodiments, the vapor contains between about 90% and about 100% acetic acid by weight. In some embodiments, the vapor contains at least about 98% acetic acid by weight. The remainder of composition may be any compound or combination of compounds that does not unduly interfere with the esterification. In some embodiments, the boiled composition also contains one or more diluents in addition to the acetic acid. In some embodiments, the composition contains acetic anhydride, for example where the vapor is the result of boiling a composition that contains between about 90% and 99% acetic acid and about 1% to about 10% acetic anhydride by weight. In some embodiments, the composition contains acetic anhydride, for example where the vapor is the result of boiling a composition that contains about 95% acetic acid and about 5% acetic anhydride by weight. In some embodiments, the composition contains acetic anhydride, for example where the vapor is the result of boiling a composition that contains about 99% acetic acid and about 1% acetic anhydride by weight. Thus, in some embodiments the vapor stream is the result of boiling a composition that contains both acetic anhydride and acetic acid. In some embodiments, the vapor stream is the result of boiling a composition that contains acetic acid in one of the percentages above, and acetic anhydride (e.g., about 80:20 acid/anhydride, about 85:15 acid/anhydride, about 90:10 acid/anhydride, or about 95:5 acid/anhydride). Thus, in some embodiments, the vapor has an acid/anhydride ratio in the range from about 50:50 to about 99:1. In some embodiments, the vapor has an acid/anhydride ratio in the range from about 75:25 to about 99:1. In some embodiments, the vapor has an acid/anhydride ratio in the range from about 75:25 to about 95:1. The boiling can occur at a temperature effective to allow the vapor to boil and enter the pressurized reactor.

In some embodiments, the boiled composition also contains one or more other components in addition to the acetic acid, acetic anhydride, or both. Example diluents include xylene, methanol, acetone, methyl isobutyl ketone, ester solvents (e.g. acetate esters such as isopropyl acetate, n-propyl acetate etc.) and combinations of two or more of the foregoing. In some embodiments, the vapor has the same composition by weight as the liquid that was boiled to produce the vapor.

In some embodiments, the heat transfer medium may be generated by boiling acetic anhydride and/or acetic acid that has been previously used in is a byproduct of an acetylation process. Such material may or may not contain wood byproduct materials and derivatives thereof. Some examples of such derivatives include tannins and other polyphenolics, coloring matter, essential oils, fats, resins, waxes, gum starch, or metabolic intermediates.

Processes that Include Multiple Acetylation Cycles

The invention relates to processes in which at least some of the solid wood undergoes a plurality of acetylation cycles. While wood of any density may be used in the methods of the invention, multiple acetylation cycles are particularly useful in some embodiments that involve acetylating higher density wood or batches of wood that include higher density wood. Density can indicate the porosity of the wood (that is, denser material can be less porous), which in turns indicates the relative volume of space per volume of wood that is available for impregnation with acetic anhydride, and ultimately the amount of acetic anhydride that can be made available for acetylation reaction with the wood. In some cases, denser wood typically possesses less pore space and thus is generally capable of uptaking smaller amounts of acetic anhydride than some less dense wood, particularly within the same species. Use of multiple acetylation cycles thus allows for removing at least some byproduct from the pore volume after a first acetylation cycle and replacing it with fresh acetic anhydride for a second acetylation cycle.

It has been found, however, that there are a variety of ways in which the efficiency of processes that use multiple acetylation cycles can be enhanced by varying parameters between the cycles. For example, it has been found that in some embodiments the replacement of liquid byproduct in the wood from a sequentially earlier acetylation cycle with fresh acetic anhydride in the impregnation step of one or more sequentially subsequent acetylation cycles can improve the degree of acetylation in the overall process to such degree that embodiments can be used in which at least one acetylation cycle is less robust than at least one other cycle.

As used throughout this application, referring to an acetylation cycle as “less robust” than another shall mean that the conditions and parameters (other than degree of impregnation) used in the reaction step of the cycle are less conducive to more rapid and/or thorough acetylation of hydroxyl sites in the wood. Referring to a cycle as “more robust” has the opposite meaning.

Varying robustness between steps can confer advantages. For example, it may be desirable in some embodiments to subject the acetylated material to reduced pressure, particularly pressure below atmospheric (i.e. a “flash” step) after the completion of the last acetylation cycle to cause evaporation of byproduct liquids (containing, among other things, acetic acid) in the acetylated wood. This flash step reduces the amount of material that must be removed by subsequent heating or other byproduct removal steps (e.g. heat drying), providing greater efficiency to the overall manufacturing process. Increasing the enthalpy produced by the exothermic acetylation reaction of the sequentially final acetylation cycle allows the wood to attain a higher temperature during flash and thus facilitates more thorough evaporation of the byproduct materials. When multiple acetylation cycles are used however, some of the acetylation reaction occurs in sequentially previous acetylation cycles and the amount of acetylation reaction and enthalpy produced in a sequentially final acetylation cycle will be less than that in a single acetylation cycles. It may thus be desirable to increase or even maximize the relative amount of acetylation reaction that occurs in the sequentially final cycle while reducing the amount of reaction that occurs in the earlier cycles. Thus in some embodiments, the sequentially final acetylation cycle is more robust than one, some or all of the previous acetylation cycles.

Reaction steps (and therefore acetylation cycles) are made more or less robust by manipulating any of a variety of parameters (other than degree of impregnation) that are conducive to acetylation of reaction sites throughout the wood. For example, an acetylation cycle can be made more robust by increasing the rate at which heat is applied during the reaction step, the duration of heat application or both. In some embodiments in which the heat is provided through electromagnetic radiation, for example, the intensity or duration (or both) of the radiation can be increased to render the acetylation cycle more robust. In some embodiments in which the heat is applied using a heated gas, cycles can be made more robust or less robust by, for example, manipulating the temperature of the gas, the rate at which the gas is added or the duration for which gas is added. Thus, increasing the temperature of the gas, the rate at which the heated gas is applied or the duration of gas application are each examples of ways to make the acetylation cycle more robust. In embodiments in which acetylation reactions occur within pressurized vessels, controlling pressure within the vessel alters the boiling point of acetic acid byproduct and other liquid materials in the wood that boil off during the acetylation reaction, and thus provides a way to manipulate board temperatures. Thus increasing the pressure or the duration at which the pressure is held at an elevated level are examples of ways in which an acetylation cycle can be made more robust.

It has further been found that in some embodiments of multiple acetylation it is advantageous to have one or more acetylation cycles in which the impregnation step is less robust than in other cycles. This cycle having a less robust impregnation step may be a more robust acetylation cycle or a less robust acetylation cycle. In some embodiments, for example, the sequentially final acetylation cycle has a less robust impregnation step than sequentially previous acetylation cycles in the process. In some embodiments, the sequentially final acetylation cycle has a less robust impregnation step despite being a more robust acetylation cycle (i.e. in terms of the reaction step parameters discussed above) than any other cycles in the process. It has been found in some embodiments that less robust impregnation is beneficial in some sequentially final cycles, due to acetylation that has already occurred in previous cycles, the presence of residual anhydride from previous cycles, or both. Furthermore, it can be advantageous in some embodiments to use less robust impregnation in a sequentially final acetylation cycle because more robust impregnation with acetic anhydride can result in the presence of a greater amount of unreacted acetic anhydride (rather than byproduct acetic acid) being present in the wood after the reaction step is complete. This can be disadvantageous because it reduces the efficiency of acetic anhydride use. Higher levels of anhydride in the wood after the reaction step can also reduce the efficiency of the flash and other evaporative byproduct removal processes because acetic anhydride has a higher boiling temperature than acetic acid. Thus, in some embodiments, one or more of the acetylation cycles may have both a less robust impregnation step and more robust reaction step than other acetylation cycles. In some embodiments, this is the sequentially final cycle.

As used throughout this application, a “more robust” impregnation step is a step in which the mass uptake of impregnating fluid is higher and a “less robust” impregnation step is a step in which the mass uptake of impregnating fluid is lower. Mass uptake can be measured, for example, by comparing the volume of free impregnating fluid available before and after impregnation. In some embodiments, the less robust cycles cause the wood to be impregnated with about 0.05 to about 0.50 fewer grams of impregnating fluid per gram of wood than more robust cycles. Embodiments also exist in which this range may be, for example, from about 1.00 to about 5.00, from about 0.05 to about 0.30, from about 0.05 to about 0.20, from about 0.05 to about 0.15, from about 1.00 to about 2.00, from about 2.00 to about 4.00, from about 3.00 to about 5.00, from about 1.00 to about 3.00 or from about 2.00 to about 3.00. In some embodiments, the less robust cycles cause the wood to be impregnated with at least about 0.05 fewer grams of impregnating fluid per gram of wood than more robust cycles. In some embodiments, the less robust cycles cause the wood to be impregnated with at least about 1.0 fewer grams of impregnating fluid per gram of wood than more robust cycles. In some embodiments, the less robust cycles cause the wood to be impregnated with at least about 2.0 fewer grams of impregnating fluid per gram of wood than more robust cycles.

Robustness of impregnation can be varied by manipulating a variety of parameters. One example is shortening the period of contact with the impregnating fluid. Where the wood is subjected to elevated pressure (i.e. above ambient) during contact with impregnating fluid, some embodiments involve acetylation cycles that differ in the maximum pressure attained, the duration of pressurization, or both. Similarly, where the wood is subjected to reduced pressure (i.e. below ambient), such as before or during contact with impregnating fluid, some embodiments involve acetylation cycles that differ in the minimum pressure attained, the duration of depressurization, or both. Some other parameters that can be manipulated include the order and number of pressurization and depressurization steps. Embodiments exist that include combinations of any or all of the foregoing manipulations to create differing conditions between acetylation cycles. Lowering the concentration of acetic anhydride in the impregnating fluid can also render the impregnation step less robust.

Using one or more less robust impregnation steps also allows multiple acetylation cycles to require less overall uptake. In some embodiments of multiple acetylation cycles, the overall uptake of impregnating fluid (i.e. the sum of uptake from all cycles) is from about 0.80 to about 2.00 grams of impregnating fluid per gram of wood than more robust cycles. In various embodiments, this range is from about 1.00 to about 1.70, from about 1.20 to about 1.50 or from about 1.20 to about 1.30 grams of impregnating fluid per gram of wood than more robust cycles.

### Density Sorting and Processing Accordingly

As noted above, use of multiple acetylation cycles can be particularly useful for obtaining a desired degree of acetylation with solid wood having a higher density. It has been discovered, however, that in some embodiments, subjecting wood with lower density to the same acetylation procedures as that of higher density can be disadvantageous. For example, multiple impregnation processes associated with multiple acetylation cycles that achieve the desired degree of impregnation for higher density material may cause less dense wood to take up more material than needed for the desired degree of acetylation, especially when multiple acetylation cycles are used. This can result in use of too much acetic anhydride, reducing process efficiency and increasing the amount of acetic anhydride in any liquid byproduct material contained in the acetylated solid wood after completion of the last cycle. Furthermore, the fact that unreacted acetic anhydride has a higher boiling point than the byproduct acetic acid means that the presence of more acetic anhydride can make removing byproduct after acetylation through flash or other heat-related processes less efficient and effective. It would thus be advantageous to develop methods that provide the needed degree of acetylation for denser materials without impregnating lower density wood with excessive levels of acetic anhydride.

Thus, in some embodiments, the method includes sorting individual pieces of acetylated solid wood into a high-density group and a low-density group and subjecting at least the majority of the solid wood pieces in the high-density group of solid wood pieces to at least one more acetylation cycle than the majority of solid wood pieces in the low-density group of the solid wood pieces. As used throughout this application, “majority” means greater than 50% of the individual pieces. Thus, at least 50% of the solid wood pieces in the high-density group of solid wood pieces undergo at least one more acetylation cycle than at least 50% of the solid wood pieces in the low-density group. In some embodiments, the number of pieces in the high-density group that are subjected to more acetylation cycles than the majority of the low-density group can be described as at least any value above 50%, such as at least 55%, 60%, 65%, 70%, 75%, 80%, 85%, 90%, 95%, 97%, or 99%. In some embodiments, 100% of the solid wood pieces in the high-density group undergo at least one more acetylation cycle than the majority of solid wood pieces in the low-density group. Similarly, the number of pieces in the low-density group that are subjected to fewer acetylation cycles than the majority of high-density group can be described as at least any value above 50%, such as at least 55%, 60%, 65%, 70%, 75%, 80%, 85%, 90%, 95%, 97%, or 99%. In some embodiments, 100% of the solid wood pieces in the low-density group undergo at least one fewer acetylation cycle than the majority of solid wood pieces in the high-density group. In some embodiments, 100% of the solid wood pieces in the low-density group undergo at least one fewer acetylation cycle than 100% of solid wood pieces in the high-density group.

In some embodiments, solid wood pieces may also be scanned or sorted for other factors, such as physical or visible flaws, defects or other features that make the wood undesirable or out of compliance with a raw material specification. For example, wood observed to have unacceptable amounts or severity of warping, cracking, checking, knots or discoloration may be removed from a group of solid wood pieces. Wood pieces that are removed from a process for such reasons will be referred as “off-specification pieces” throughout this application and pieces that are not removed for such reasons shall be referred to “on-specification pieces.” In some embodiments, removal of off-specification pieces occurs prior to density sorting. In some embodiments, removal of off-specification pieces occurs after the completion of acetylation cycles. In some embodiments, however, off-specification pieces are removed after density sorting and before the commencement of acetylation cycles. In some embodiments where sorting occurs at that time, “a majority of solid wood pieces” in a particular group referred to in the previous paragraph (such as a “majority” of the high density group or a “majority” of the low density group) refers to a majority of the solid wood pieces that are on-specification pieces in that group rather than the majority of all pieces. Thus, in some embodiments of each of the percentages set forth in the previous paragraph (such as 100% or at least 50%, 55%, 60%, 65%, 70%, 75%, 80%, 85%, 90%, 95%, 97%, or 99%) as examples of majorities, such percentages refer to the percentage of on-specification pieces in a group.

Density sorting may be accomplished by placing the pieces of solid wood into the high-density group or the low-density group based a density-indicating parameter measured for the individual pieces and the relationship of each measured value to a threshold value. Each individual piece for which the density-indicating parameter measures the exact threshold value is placed with the low-density group in some embodiments, and with the high-density group in other embodiments. Thus, in some embodiments, the “low-density group” has a density below the threshold value and the “high-density group” has a density at or above the threshold value. In some embodiments, the “low-density group” has a density at or below the threshold value and the “high-density group” has a density above the threshold value.

As noted above, the high-density group then undergoes at least one more acetylation cycle than the low-density group. In some embodiments, the low-density group undergoes one acetylation cycle and the high-density group undergoes two or more acetylation cycles. In some embodiments, both groups undergo two or more acetylation cycles, but the high-density group undergoes at least one more acetylation cycle than the low-density group.

In some embodiments, the sorting process involves determining a density-indicating parameter and measuring an actual value for the density-indicating parameter for each of a plurality of the solid wood pieces. The density-indicating parameter is a measurable parameter that is either the density itself or another parameter that can be used to calculate or to otherwise indicate the density of a piece of solid wood. Any suitable parameter and any suitable means for measuring density itself or the parameter may be used. Some parameters that may be used include mass of the piece (where the dimensions are known) porosity, number of growth rings per inch of thickness, the extent to which material is old growth, extractive content, heartwood content, and the acoustic properties of the wood. In embodiments in which dimensions of pieces of wood are consistent throughout the population of pieces being measured, mass can be a convenient option. Some other examples of density-measuring devices include those that measure the degree of attenuation for microwave, infrared (e.g. “near infrared”) radio frequency, or other forms of radiation in the material.

In some embodiments, density is determined on a dry basis. Where solid wood contains water, water content is accounted for and wet density numbers can be adjusted based on water content to provide dry density. In some embodiments, water content is determined or measured for this purpose. Any effective method of measuring water may be used. For example, where wood is kiln dried prior to acetylation, measurements of a representative sample of the kiln batch can be used to calculate water levels for solid wood pieces from the same batch. Water content can be measured, using any suitable means. In some embodiments, water is measured using a Delmhorst model RDM3 water meter, available from Delmhorst Instrument Co., Towaco, N.J., USA, or using equivalent measurements. Some other examples include electromagnetic radiation measurements such as devices that measure the degree of attenuation for microwave, infrared (e.g. “near infrared”) radio frequency, or other forms of radiation. In some embodiments, measurements of “wet density” and water content may be made simultaneously, for example using in-line equipment to measure these for each board, then used to calculate dry density on a board-by-board basis.

Thus, in some embodiments the threshold value and actual values for density-indicating parameter measurements indicate dry density. In some embodiments, density-indicating parameter measurements indicate wet density, and the method further includes identifying the water content of the pieces and adjusting the threshold value for one or more pieces to a wet density to account for the identified water content in a manner that corresponds to a desired dry density value. Although sorting based on dry density is more directly indicative of available pore space, reliable sorting can be accomplished with wet density, for example by a process such as that described above.

Measurements of the density-indicating parameter for individual pieces of wood are compared against a threshold value for that parameter, and pieces of solid wood are sorted into high-density and low-density parameters accordingly. Because a variety of parameters may be used to indicate density, it is convenient to describe the threshold values for density-indicating parameters by referring to the (dry) densities that they indicate. In some embodiments, the threshold value for the density-indicating parameter is selected from the range of parameter values that indicate a density in the range of 0.45-0.70 grams per cubic centimeter (g/cc) prior to acetylation. The specific desirable ranges for a given application will depend on the water content of the wood and the desired degree of acetylation. For example, various embodiments exist for which the threshold value indicates a density in each of the following ranges: 0.50-0.65 g/cc; 0.55-0.60 g/cc; 0.45-0.55 g/cc; 0.50-0.60 g/cc; 0.60-0.70 g/cc; 0.45-0.50 g/cc; 0.50-0.55 g/cc; 0.60-0.65 g/cc; 0.44-0.46 g/cc; 0.46-0.48 g/cc; 0.48-0.50 g/cc; 0.50-0.52 g/cc; 0.52-0.54 g/cc; 0.56-0.58 g/cc; 0.58-0.60 g/cc; 0.60-0.62 g/cc; 0.62-0.64 g/cc; 0.64-0.66 g/cc; 0.66-0.68 g/cc; or 0.68-0.70 g/cc. The density indicated by the threshold value may also be described by combining any two or more adjacent ranges from the foregoing group, such as combining 0.56-0.58 g/cc with 0.58-0.60 g/cc to provide a range of 0.56-0.60 g/cc, or combining 0.50-0.52 g/cc, 0.52-0.54 g/cc and 0.56-0.58 g/cc to provide a range of 0.50-0.58 g/cc. The density indicated by the threshold value may also be described as single vales, such as the various separate embodiments in which the threshold value indicates each of these individual densities: 0.45; 0.46; 0.47; 0.48; 0.49; 0.50; 0.51; 0.52; 0.53; 0.54; 0.55; 0.56; 0.57; 0.58; 0.59; 0.60; 0.61; 0.62; 0.63; 0.63; 0.64; 0.65; 0.66; 0.67; 0.68; 0.69; or 0.70 g/cc. Embodiments exist in which each of the foregoing values in the paragraph represent the actual (dry) density measurement. Embodiments also exist in which each of the foregoing values in this paragraph represent the density determined on a “95/5 impregnant and 6% wood water basis,” as described in detail below.

The threshold value is determined based on the desired degree of acetylation to be achieved for the pieces, the degree to which variability in degree of acetylation is acceptable, and knowledge of any other properties of the solid wood that affect the resulting degree of acetylation. One such property is the water content of the wood. As noted above, density can indicate the volume of space available for impregnation with acetic anhydride in the wood. Water present in the wood also reacts with acetic anhydride, thus reducing the degree to which acetic anhydride that enters the wood will be available for acetylation reaction. Higher water content can thus reduce the resulting degree of acetylation in a given acetylation cycle, thus making the cycle less effective. For this reason, methods of the invention can also be described as having a threshold value that corresponds to a specific water content value. For example, in some embodiments where a threshold value indicating a density of 0.57 g/cc is used for solid wood pieces having a mean water content of about 6%, an equivalent degree of acetylation under identical conditions can be obtained for solid wood pieces having a mean content of about 8% using a threshold value that indicates a density of 0.53 g/cc, and an equivalent degree of acetylation under identical conditions can also be obtained for solid wood pieces having a mean content of about 4% using a threshold value that indicates a density of 0.63 g/cc. The amount of acetic anhydride in the impregnating liquid is a factor that can alter the threshold values because it affects the number of acetic anhydride molecules that will be available inside the solid wood. Thus, in some embodiments using a 95% acetic anhydride/5% acetic acid solution as the impregnating liquid, an equivalent degree of acetylation under identical conditions can be obtained for identical solid wood pieces (including an identical density) using a 99% acetic anhydride/1% acetic acid solution using a threshold value that indicates a density of 0.01 g/cc higher. To account for the effect of variability of water in the solid wood and acetic anhydride content of the impregnating fluid, the threshold value can be described as indicating the density for the water content of the wood that achieves the equivalent degree of acetylation that is achieved at a specified density with a solid wood water content of 6% and an impregnating liquid containing 95% acetic anhydride and 5% acetic acid. This value can be described as the “95/5 impregnant and 6% wood water basis.” Thus, all of the density values in the paragraph immediately prior to this paragraph correspond not only to actual densities but also densities on a 95/5 impregnant and 6% wood water basis.

The sorting process can be entirely manual, or all or partially automated. In some embodiments, for example, the density-indicating parameter is determined manually and the pieces of solid wood are physically sorted by manual or automated means. The density-indicating parameter may also be determined by an automated process. The results may be used in sorting pieces of solid wood by manual means or may be used in an automated sorting system. For example, the density-indicating parameter measurement may be fed to an operating system that makes a density determination based on the relationship between the measured value and the threshold, then transmits a signal to manual or automated transport processes indicating whether the piece of solid wood should be transported to storage or process units associated with the low-density group or those associated with the high-density group.

After sorting, the low-density groups and high-density groups may then be placed into appropriate acetylation cycles or groups of cycles. In some embodiments, the low-density and high-density groups are subject to one or more identical acetylation cycles, but the high-density groups are further subjected to one or more additional acetylation cycle that may or may not be identical to sequentially earlier acetylation cycles. In some embodiments, the low-density group is subject to one acetylation cycle, and the high-density groups are further subjected to two or more acetylation cycles that each differ from the acetylation cycle used on the low-density group. In some embodiments, the low-density group is subject to one or more acetylation cycles that differ from the acetylation cycles used for the high-density group. For example, in some embodiments, one or more of the acetylation cycles for the high-density group is less robust than that for one or more of the acetylation cycles for the solid wood pieces in the low-density group. In some embodiments, all of the acetylation cycles for the high-density group are less robust than the acetylation cycles for the solid wood pieces in the low-density group. Each of the combinations of cycles including varying degrees of cycle robustness and impregnation step robustness that are discussed elsewhere in the application may be used.

As described above, there are a number of techniques available to vary the degree of robustness of an acetylation cycle or the robustness of an impregnation step. Any combination of two or more of these techniques can be used to cause one or more of the acetylation cycles for the high-density group to be less robust that those one or more of those of the low-density group.

### Degree of Acetylation

The resulting acetylated wood has a desired degree of acetylation, which is measured as the percent bound acetyl groups in the wood. As used herein, “percent bound acetyl” or “percent bound acetyl groups” is determined according to the following procedure. A piece of acetylated solid wood is sampled by cutting a 1 foot long section from the end of the board. This section is sampled by drilling a hole through its entire width using ¾″ Forstner bit. The hole is made on the largest face of the piece at a location that is 1 inch from the cut end of the piece and at the middle of the width of the piece. Samples are weighed (to the nearest 0.1 mg) to determine the dry sample weight, as follows: An 8 dram vial and cap is placed on a balance, the weight is recorded, and the balance is tared. Into the open vial, with cap on the balance, 0.4900 to 0.5100 g of the sample of the shavings is added and the weight recorded to the nearest 0.0001 g. The vialed sample, without the cap, is then dried in a convection oven set to 105° C. for at least 16 hours. Sample vials are then capped and allowed to cool to room temperature. 20 mL of aqueous 1N (4% (w/v)) sodium hydroxide (Mallinckrodt #7708-10, or equivalent) are pipetted into the vial, and the vial is sealed again and placed in a 50° C. water bath for at least four hours. Contents are mixed both before and after the water bath by shaking for a few seconds, and allowing the wood shavings to settle. 200 microliters of the liquid supernatant is pipetted into a 10 mL flask, 0.1 mL of 85% phosphoric acid (Mallinckrodt #2796, or equivalent) is added, and the liquid is diluted to 10 mL with HPLC grade water (ASTM Type 1 HPLC grade). The resulting solution is mixed thoroughly and, if the solution contains sample particles, filtered to remove the particles.

The acetic acid content of the filtered solution is then determined by reversed phase liquid chromatography using a HYDROBOND PS-C18 column (MAC MOD Analytical Inc., Chadd's Ford, Pa.), or equivalent, the column held at 35 degrees C. using an Agilent Column Compartment, or equivalent, with detection using an Agilent 1100 Series Variable Wavelength Detector (Agilent Technologies, Inc., Santa Clara Calif.) or equivalent at 210 nm. The acetic acid is separated isocratically using 50 millimolar phosphoric acid for seven minutes and the acetic acid (retention time approximately four minutes) is then photometrically detected at 210 nm. The column is flushed with methanol and reequilibrated after every ten samples. A calibration curve is prepared over the range of 10-1000 ppm (corresponding to masses of 0.001-0.10 g of acetic acid in 100 mL calibration solutions). For the sample, the resultant area under the acetic acid peak is compared against the calibration curve to provide the weight of acetic acid in the sample. The determined weight of acetic acid (Acetic Acid) is then multiplied by a ratio representing the mole weight of the acetyl group divided by the mole weight of acetic acid (that is, 43/60). The product is then divided by the dry weight of the sample in grams (Sample weight, in grams) then multiplied by 100 to express the value as a percent bound acetyl. This can be shown in the following equation: % Bound Acetyl=(weight of Acetic Acid×43/60×100)/Sample weight, in grams.

In some embodiments, the process produces acetylated solid wood in which degree of acetylation is from about 5 to about 35%. In various different embodiments, the method produce acetylated solid wood in which the degree of acetylation is in each of the following ranges: about from 10 to about 30%, from about 15 to about 30%, from about 10 to about 25%, or from about 15 to about 25%. Embodiments exist for each of the foregoing ranges in which all of the pieces of acetylated solid wood produced in a given acetylation batch fall within the ranges. Embodiments also exist for each of the foregoing ranges in which the mean degree of acetylation for pieces of solid wood produced in a given acetylation batch fall within the ranges.

Various aspects of the present invention can be further illustrated and described by the following Examples. It should be understood, however, that these Examples are included merely for purposes of illustration and are not intended to limit the scope of the invention, unless otherwise specifically indicated.

### EXAMPLES

The following experiments were conducted using the apparatus and process described below. A sealed cylindrical horizontal steel vessel that was sufficiently airtight and watertight to serve as a reactor and that had dimensions of approximately 13 feet in length and 20 inches in diameter was constructed. The working volume of the reactor was 200 gallons and the reactor was outfitted to hold up to 18 boards having dimensions of twelve feet length by 5.5 inches width by 1 inch thickness. The reactor was enclosed within a twenty-two inch diameter pipe serving as an oil jacket that contained oil that could be heated by pumping through a heat exchanger. The reactor also had the ability to reduce and increase pressure.

### Example 1

Eighteen 12′×5.5 inch×1 inch boards of Southern Yellow Pine were placed in the reactor (with a twelve feet by 5.5 inch surface facing upwards) and separated from each other vertically by a rack that separated the boards by 0.5 inches and distributed free flow of gasses in the reactor across the faces of the boards. The boards had been kiln dried using a procedure that resulted in an average water content of the boards of 6%, as measured by the Delmhurst meter describe above, based on a random sampling of approximately 5% of the kiln charge. No boards were higher than 8% water content. Sensitivity calculations confirmed that the potential variability in % water content would not make a significant difference in the bone dry density calculated using the measured “wet” weight and the average % water content. A thermocouple was inserted into a pre-drilled hole in the side of the bottom of up to 6 boards at a location approximately two feet from the end of the board.

The following procedure was used for boards acetylated with a single acetylation cycle. The reaction vessel pressure was reduced to under 60 mm Hg using a steam jet and held there for 15 minutes. With continued vacuum, acetic anhydride (>95% acetic anhydride; <5% acetic acid) was added to fill the reactor such that the boards were completely submerged in acetic anhydride liquid. The reaction vessel pressure was then increased to 5000 mm Hg and held at that pressure for 15 minutes. Excess liquid (i.e. not absorbed into the boards) was drained from the vessel and the vessel pressure was reduced to 1800 mm Hg.

Heating of the oil jacket was then commenced. Hot vapors were generated by boiling a liquid containing approximately 95% acetic acid and 5% acetic anhydride in a steam jacketed pipe (nominal 90 psig steam pressure) and introducing the vapors into the reactor to deliver heat to the boards. Vapor delivery was through a vapor port located approximately in the center of the length of the boards on the top of the vessel. The flow of vapor continued either until either the temperature measured in gasses vented from the vessel vent spiked above 40 degrees C. or for 100 minutes, whichever occurred first. After the flow of vapor was discontinued, the vessel pressure during the acetylation was raised to 2000 mm Hg and maintained for 60 minutes. Any liquid that condensed in the bottom of the reactor during this period was evacuated using the vessel pressure to move the liquid to a separate atmospheric tank.

After completion of the reaction step, the following flash and drying procedure was used. The pressure in the reaction vessel was then vented and then reduced further with the vacuum jet to a prescribed level between 75-80 mmHg and held for 30 minutes. Vacuum was then relieved to atmospheric pressure with nitrogen gas that had been heated to a target temperature of 155 degrees C. The hot nitrogen was circulated through the vessel at atmospheric pressure using an external blower, and the temperature of the nitrogen was maintained at 150-155 degrees C. using an external heat exchanger with 100 psig steam as the heating medium. This nitrogen flow was maintained until the temperature of the wood, as measured though the thermocouple inserted into at least one board, was above 150C. At this point the flow of nitrogen was stopped, and the pressure was reduced in the vessel to below 75 mmHg. That pressure was maintained below 75 mmHg for 30 minutes. During this pressure reduction and hold, the temperature of the wood decreases approximately 15-20 degrees C. due to the evaporation of byproduct acetic acid and unreacted acetic anhydride from the wood. The pressure in the vessel was then increased to atmospheric pressure with heated nitrogen at 150-155 degrees C. This heated nitrogen was circulated through the vessel at atmospheric pressure until the wood temperature was again above 150C. The nitrogen flow was then stopped, and pressure was reduced to below 75 mmHg and held below that pressure for 30 minutes. The pressure was increased to atmospheric pressure with ambient nitrogen, and the vessel and wood were allowed to cool to below 60 C before unloading the wood from the vessel. The boards were then subjected to further processing to evaporate further the acetylation byproducts and any other liquids remaining in the boards.

All percent bound acetyls were measured using the method described above in this application. Boards were sampled as follows: Samples were taken by drilling a hole with a ¾″ Forstner bit at a location on the twelve feet by 5.5 inch surface at a location one foot from the end of the board and at the approximate middle of the width of the board with deviation from the middle allowed to avoid sampling in obvious heartwood. A hole was drilled all the way through the board. All drill shavings from the hole were combined and mixed for testing.

### Unsorted, Single Acetylated Boards

A total of 15 batches containing 256 boards were acetylated using the procedure described above. Dry density of the boards was determined after an initial kiln drying step and equilibration in a warehouse to a water content of 12 +/−2% as measured by the Delmhorst meter described above. The density was determined by measuring the mass of the boards, then calculating density based on board dimensions and an average water content of 12%. The boards were then further kiln dried to a mean of 6% water, as measured on approximately 5% of the boards using the Delmhorst meter. The boards were then subjected to one acetylation cycle using the procedures described above. Percent bound acetyls was then measured for each board. Dry density and percent bound acetyl are presented in Table 1 below.

TABLE 1

| Board # | Dry Density | % BA |
|---|---|---|
| 1 | 0.509 | 18.3 |
| 3 | 0.593 | 11.1 |
| 4 | 0.430 | 22.1 |
| 5 | 0.567 | 16 |
| 6 | 0.541 | 18.2 |
| 7 | 0.557 | 16.6 |
| 8 | 0.507 | 20.3 |
| 9 | 0.493 | 16.6 |
| 10 | 0.446 | 23.2 |
| 14 | 0.573 | 12.6 |
| 15 | 0.466 | 19.7 |
| 17 | 0.497 | 18.5 |
| 18 | 0.517 | 17.9 |
| 19 | 0.537 | 16.4 |
| 20 | 0.444 | 21.3 |
| 21 | 0.527 | 19.2 |
| 22 | 0.569 | 16.6 |
| 23 | 0.585 | 15.2 |
| 24 | 0.561 | 15.1 |
| 25 | 0.533 | 17.2 |
| 26 | 0.516 | 18.4 |
| 27 | 0.575 | 16.3 |
| 28 | 0.558 | 18.7 |
| 29 | 0.539 | 17.5 |
| 30 | 0.599 | 16.4 |
| 31 | 0.464 | 18.9 |
| 32 | 0.551 | 18.9 |
| 33 | 0.525 | 18.9 |
| 34 | 0.559 | 18.9 |
| 35 | 0.479 | 15.9 |
| 36 | 0.542 | 17.2 |
| 37 | 0.577 | 14.4 |
| 38 | 0.545 | 16.4 |
| 39 | 0.471 | 21.1 |
| 40 | 0.522 | 19.7 |
| 41 | 0.554 | 19.2 |
| 42 | 0.498 | 20.5 |
| 43 | 0.559 | 16.3 |
| 44 | 0.552 | 19.7 |
| 45 | 0.528 | 21.3 |
| 46 | 0.468 | 21.8 |
| 47 | 0.445 | 21.1 |
| 48 | 0.532 | 20 |
| 49 | 0.483 | 19.5 |
| 50 | 0.521 | 17 |
| 51 | 0.566 | 18.9 |
| 52 | 0.515 | 19.9 |
| 53 | 0.491 | 18.4 |
| 54 | 0.574 | 15.4 |
| 55 | 0.568 | 20 |
| 56 | 0.584 | 19.3 |
| 57 | 0.551 | 19 |
| 58 | 0.535 | 16.3 |
| 59 | 0.456 | 21.5 |
| 60 | 0.535 | 19.4 |
| 61 | 0.500 | 19.5 |
| 62 | 0.520 | 18.2 |
| 63 | 0.562 | 18.9 |
| 64 | 0.469 | 20.1 |
| 65 | 0.521 | 20.3 |
| 66 | 0.471 | 22 |
| 67 | 0.525 | 19.2 |
| 68 | 0.528 | 19.6 |
| 69 | 0.500 | 17.7 |
| 70 | 0.568 | 19.7 |
| 71 | 0.572 | 16.7 |
| 72 | 0.524 | 23.3 |
| 73 | 0.449 | 20.6 |
| 74 | 0.563 | 19.6 |
| 75 | 0.552 | 18.9 |
| 76 | 0.514 | 16.4 |
| 77 | 0.464 | 19.9 |
| 78 | 0.474 | 21.8 |
| 79 | 0.547 | 18.5 |
| 80 | 0.431 | 21.1 |
| 81 | 0.503 | 22.1 |
| 82 | 0.537 | 20.3 |
| 84 | 0.543 | 18.4 |
| 85 | 0.417 | 20.1 |
| 86 | 0.564 | 19 |
| 87 | 0.542 | 20.1 |
| 88 | 0.529 | 20.4 |
| 89 | 0.459 | 19.2 |
| 90 | 0.484 | 21.4 |
| 91 | 0.518 | 20.2 |
| 92 | 0.476 | 18.2 |
| 93 | 0.550 | 14.9 |
| 94 | 0.429 | 20.1 |
| 95 | 0.545 | 19.4 |
| 96 | 0.511 | 18 |
| 97 | 0.413 | 20.6 |
| 98 | 0.532 | 20.2 |
| 99 | 0.555 | 18.5 |
| 100 | 0.628 | 7.2 |
| 101 | 0.528 | 22.9 |
| 102 | 0.518 | 20.7 |
| 103 | 0.492 | 21.4 |
| 104 | 0.522 | 18.4 |
| 105 | 0.578 | 15.5 |
| 106 | 0.546 | 16.8 |
| 107 | 0.594 | 14.9 |
| 108 | 0.525 | 19.5 |
| 109 | 0.548 | 22 |
| 110 | 0.420 | 19.2 |
| 111 | 0.467 | 18 |
| 112 | 0.579 | 16.6 |
| 113 | 0.581 | 13.1 |
| 114 | 0.562 | 19.6 |
| 115 | 0.487 | 20.9 |
| 116 | 0.482 | 19.7 |
| 117 | 0.566 | 10.7 |
| 118 | 0.552 | 17.7 |
| 119 | 0.535 | 18.9 |
| 120 | 0.499 | 20.3 |
| 121 | 0.532 | 17.5 |
| 122 | 0.541 | 14.2 |
| 123 | 0.475 | 18.2 |
| 124 | 0.562 | 15.7 |
| 125 | 0.472 | 16.3 |
| 126 | 0.487 | 22.7 |
| 127 | 0.635 | 12.9 |
| 128 | 0.590 | 17.2 |
| 129 | 0.495 | 19.7 |
| 130 | 0.538 | 17.7 |
| 131 | 0.489 | 20.9 |
| 132 | 0.505 | 21.7 |
| 133 | 0.445 | 23.8 |
| 134 | 0.522 | 19.9 |
| 135 | 0.548 | 20.9 |
| 136 | 0.552 | 15.1 |
| 137 | 0.465 | 21.5 |
| 138 | 0.451 | 23.9 |
| 139 | 0.492 | 20.1 |
| 140 | 0.542 | 18.5 |
| 141 | 0.488 | 20.9 |
| 142 | 0.428 | 24 |
| 143 | 0.516 | 20.1 |
| 145 | 0.465 | 21.4 |
| 146 | 0.556 | 21.6 |
| 147 | 0.559 | 20.4 |
| 148 | 0.622 | 13.8 |
| 149 | 0.486 | 19.4 |
| 150 | 0.515 | 22.4 |
| 151 | 0.555 | 17.1 |
| 152 | 0.576 | 18 |
| 153 | 0.548 | 21.3 |
| 154 | 0.569 | 19.7 |
| 155 | 0.599 | 16.3 |
| 156 | 0.593 | 18 |
| 157 | 0.577 | 17.8 |
| 158 | 0.515 | 21.5 |
| 159 | 0.492 | 21.9 |
| 160 | 0.562 | 17.7 |
| 161 | 0.526 | 21.7 |
| 162 | 0.543 | 19.3 |
| 163 | 0.510 | 19.4 |
| 164 | 0.458 | 24.1 |
| 165 | 0.620 | 15.2 |
| 166 | 0.429 | 22.8 |
| 167 | 0.450 | 21.3 |
| 168 | 0.542 | 19.5 |
| 169 | 0.501 | 22 |
| 170 | 0.489 | 19.1 |
| 171 | 0.491 | 21.5 |
| 172 | 0.572 | 18.7 |
| 173 | 0.566 | 22 |
| 174 | 0.565 | 19 |
| 175 | 0.515 | 22.1 |
| 176 | 0.539 | 19.8 |
| 177 | 0.556 | 18.6 |
| 178 | 0.542 | 20.4 |
| 179 | 0.489 | 21.8 |
| 180 | 0.645 | 14.3 |
| 181 | 0.488 | 21.9 |
| 182 | 0.479 | 21.9 |
| 183 | 0.556 | 18.4 |
| 184 | 0.587 | 16.3 |
| 185 | 0.528 | 20.3 |
| 186 | 0.577 | 10.7 |
| 187 | 0.603 | 15.8 |
| 188 | 0.637 | 13.7 |
| 189 | 0.527 | 17 |
| 190 | 0.590 | 17.7 |
| 191 | 0.567 | 12.3 |
| 192 | 0.430 | 23.5 |
| 193 | 0.548 | 21.9 |
| 194 | 0.534 | 19.3 |
| 195 | 0.488 | 20.8 |
| 196 | 0.500 | 22.4 |
| 197 | 0.503 | 21.5 |
| 198 | 0.609 | 16 |
| 199 | 0.586 | 19 |
| 200 | 0.453 | 23.9 |
| 201 | 0.499 | 21.3 |
| 202 | 0.608 | 16.4 |
| 203 | 0.644 | 13.3 |
| 204 | 0.542 | 17.2 |
| 205 | 0.589 | 14.7 |
| 206 | 0.495 | 19.7 |
| 207 | 0.482 | 20.8 |
| 208 | 0.583 | 18.7 |
| 209 | 0.508 | 21 |
| 210 | 0.609 | 16.3 |
| 211 | 0.476 | 21.3 |
| 212 | 0.559 | 18.5 |
| 213 | 0.504 | 22.6 |
| 214 | 0.588 | 19.3 |
| 215 | 0.579 | 19.5 |
| 216 | 0.567 | 14.1 |
| 217 | 0.512 | 21 |
| 218 | 0.598 | 18.7 |
| 219 | 0.562 | 19 |
| 220 | 0.564 | 17.8 |
| 221 | 0.530 | 22.5 |
| 222 | 0.565 | 15.1 |
| 223 | 0.501 | 19.1 |
| 224 | 0.531 | 20.1 |
| 226 | 0.589 | 19.5 |
| 227 | 0.622 | 18.1 |
| 228 | 0.468 | 23.4 |
| 229 | 0.518 | 22.8 |
| 230 | 0.441 | 21.3 |
| 231 | 0.545 | 19.7 |
| 232 | 0.496 | 19.6 |
| 233 | 0.518 | 20.1 |
| 234 | 0.493 | 23.2 |
| 235 | 0.506 | 21.7 |
| 236 | 0.484 | 22.2 |
| 237 | 0.573 | 18.2 |
| 238 | 0.561 | 15.5 |
| 239 | 0.471 | 22.7 |
| 240 | 0.497 | 19.6 |
| 241 | 0.514 | 16.5 |
| 242 | 0.593 | 14.4 |
| 243 | 0.509 | 22.6 |
| 244 | 0.489 | 23.6 |
| 245 | 0.514 | 20.3 |
| 246 | 0.632 | 13.1 |
| 247 | 0.526 | 17.9 |
| 248 | 0.460 | 23.2 |
| 249 | 0.435 | 24.3 |
| 250 | 0.577 | 17.8 |
| 251 | 0.429 | 23.7 |
| 252 | 0.487 | 22.5 |
| 253 | 0.568 | 12.5 |
| 254 | 0.523 | 16 |
| 255 | 0.536 | 17.6 |
| 256 | 0.505 | 21.9 |

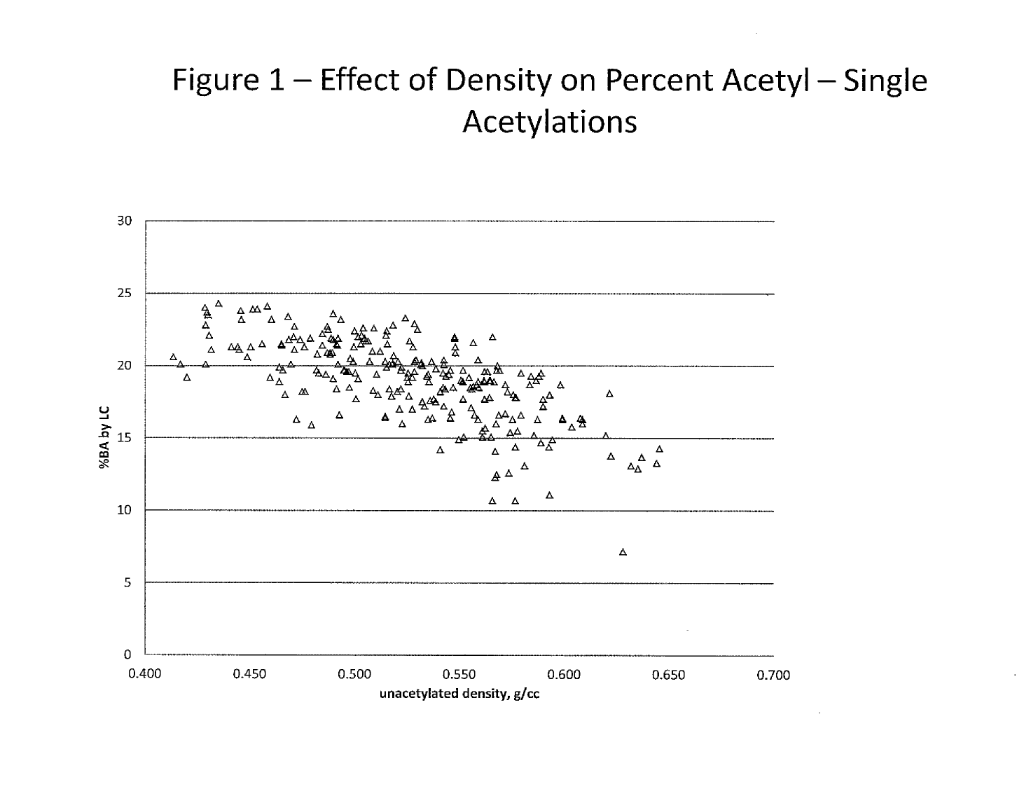

The data from Table 1 is further depicted graphically in FIG. 1. As can be seen, percent acetylation decreases steadily with increasing density.

### Sorting and Using Second Acetylation

A total of 108 boards were weighed and dry density of the boards was determined after kiln drying to 7% water by measuring the mass of the boards prior to acetylation, then calculating based on board dimensions and water content. Boards having a density of less than or equal to 0.57 grams per cubic centimeters were placed in a low-density group. All other boards were placed in a high-density group. Boards in the low-density group were then subjected to one acetylation cycle using the procedures described above. Boards in the high-density group were then subjected to two acetylation cycle using the procedures described above with the following modifications. After addition of the liquid anhydride, the impregnation pressure was increased to 1800 mmHg and held for 1-5 minutes. After draining of excess liquid, the pressure was 1800 mm Hg. The heating with acetic acid/acetic anhydride vapor mixture continued for only 60 minutes and after the vapor flow was stopped and the conditions were held at 1800 mmHg for an additional 30 minutes only. The flash and drying step did not occur after the first cycle. Instead, the pressure was then reduced to less than 80 mmHg for only five minutes and this vacuum was held while a second charge of 95% acetic anhydride/5% acetic acid liquid was added. The reactor was then pressurized to 5000 mm Hg and held for 15 minutes. After draining of excess liquid, the pressure was 5000 mmHg. Pressure during the gas application was 1800 mmHg and the pressure held until either the vent line temperature spiked above 40 degrees C. or for 80 minutes, whichever occurred first. Pressure was then increased to 2000 mmHg and held for 60 minutes. Flash and drying procedures were the same as the single acetylation cycle and further heating to reduce liquid levels were also identical. Percent bound acetyls was then measured for each board. Dry density and percent bound acetyl data for all boards are presented in Table 2 below.

TABLE 2

| | | | | | Number of |
|---|---|---|---|---|---|
| | | | | | Acetylation |
| Batch | Board | wt (g) | Dry Density | % BA | Cycles |
| 1 | a1 | 8460 | 0.61 | 20.6 | 2 |
| | b1 | 8228 | 0.59 | 22.6 | 2 |
| | b2 | 8288 | 0.59 | 20.8 | 2 |
| | c1 | 8249 | 0.59 | 21.3 | 2 |
| | c2 | 8172 | 0.59 | 22.4 | 2 |
| | d1 | 8120 | 0.58 | 21.3 | 2 |
| | d2 | 8279 | 0.59 | 21 | 2 |
| | e1 | 8320 | 0.60 | 22.2 | 2 |
| | e2 | 8076 | 0.58 | 21.6 | 2 |
| | f1 | 8515 | 0.61 | 21.8 | 2 |
| | f2 | 8078 | 0.60 | 22.5 | 2 |
| | g1 | 8929 | 0.64 | 20.9 | 2 |
| | g2 | 8234 | 0.59 | 21.4 | 2 |
| | h1 | 8712 | 0.62 | 21 | 2 |
| | h2 | 8700 | 0.62 | 21.3 | 2 |
| | i1 | 8220 | 0.59 | 22.3 | 2 |
| | i2 | 8240 | 0.59 | 22 | 2 |
| | j1 | 8250 | 0.59 | 21.6 | 2 |
| 2 | a1 | 7150 | 0.51 | 22.1 | 1 |
| | b1 | 6800 | 0.49 | 21.9 | 1 |
| | b2 | 7950 | 0.57 | 18.7 | 1 |
| | c1 | 6600 | 0.47 | 22.3 | 1 |
| | c2 | 7500 | 0.54 | 23.7 | 1 |
| | d1 | 7500 | 0.54 | 19.7 | 1 |
| | d2 | 6400 | 0.46 | 23 | 1 |
| | e1 | 7300 | 0.52 | 18.4 | 1 |
| | e2 | 7400 | 0.53 | 23.4 | 1 |
| | f1 | 6950 | 0.50 | 23.3 | 1 |
| | f2 | 7900 | 0.57 | 19.6 | 1 |
| | g1 | 7500 | 0.54 | 20.4 | 1 |
| | g2 | 7300 | 0.52 | 19.4 | 1 |
| | h1 | 6550 | 0.47 | 23.2 | 1 |
| | h2 | 7500 | 0.54 | 20 | 1 |
| | i1 | 7650 | 0.55 | 20.9 | 1 |
| | i2 | 7350 | 0.53 | 21.7 | 1 |
| | j1 | 7800 | 0.56 | 20.5 | 1 |
| 3 | a1 | 8000 | 0.57 | 15.3 | 1 |
| | b1 | 8000 | 0.57 | 14.6 | 1 |
| | b2 | 8000 | 0.57 | 18.6 | 1 |
| | c1 | 7150 | 0.51 | 22.2 | 1 |
| | c2 | 7500 | 0.54 | 18.4 | 1 |
| | d1 | 6650 | 0.48 | 23.4 | 1 |
| | d2 | 6700 | 0.48 | 24.2 | 1 |
| | e1 | 7250 | 0.52 | 22.8 | 1 |
| | e2 | 7500 | 0.54 | 20.2 | 1 |
| | f1 | 6600 | 0.47 | 21.6 | 1 |
| | f2 | 7800 | 0.56 | 17.3 | 1 |
| | g1 | 7950 | 0.57 | 19.4 | 1 |
| | g2 | 6800 | 0.49 | 23.2 | 1 |
| | h1 | 7900 | 0.57 | 18.4 | 1 |
| | h2 | 6800 | 0.49 | 19 | 1 |
| | i1 | 7500 | 0.54 | 20.5 | 1 |
| | i2 | 7500 | 0.54 | 18.7 | 1 |
| | j1 | 6600 | 0.47 | 22.4 | 1 |
| 4 | a1 | 8475 | 0.61 | 20.2 | 2 |
| | b1 | 8470 | 0.61 | 19.9 | 2 |
| | b2 | 8167 | 0.59 | 20.7 | 2 |
| | c1 | 8475 | 0.61 | 20.5 | 2 |
| | c2 | 8134 | 0.58 | 21.2 | 2 |
| | d1 | 8043 | 0.58 | 20.5 | 2 |
| | d2 | 9173 | 0.66 | 21.4 | 2 |
| | e1 | 8996 | 0.65 | 21.2 | 2 |
| | e2 | 8470 | 0.61 | 20.5 | 2 |
| | f1 | 8100 | 0.58 | 19.7 | 2 |
| | f2 | 8220 | 0.59 | 22 | 2 |
| | g1 | 8335 | 0.60 | 20.1 | 2 |
| | g2 | 8400 | 0.60 | 21.8 | 2 |
| | h1 | 8380 | 0.60 | 22.3 | 2 |
| | h2 | 8100 | 0.58 | 22.1 | 2 |
| | i1 | 8150 | 0.58 | 23.8 | 2 |
| | i2 | 8200 | 0.59 | 21.4 | 2 |
| | j1 | 8260 | 0.59 | 22.2 | 2 |
| 5 | a1 | 7654 | 0.55 | 20.9 | 1 |
| | b1 | 7667 | 0.55 | 20.1 | 1 |
| | b2 | 7541 | 0.54 | 19.2 | 1 |
| | c1 | 6670 | 0.48 | 22.9 | 1 |
| | c2 | 7740 | 0.56 | 18.2 | 1 |
| | d1 | 7870 | 0.56 | 20.9 | 1 |
| | d2 | 7365 | 0.53 | 21.4 | 1 |
| | e1 | 7670 | 0.55 | 20.8 | 1 |
| | e2 | 7213 | 0.52 | 21.6 | 1 |
| | f1 | 6750 | 0.48 | 23.1 | 1 |
| | f2 | 7430 | 0.53 | 23.4 | 1 |
| | g1 | 7171 | 0.51 | 22.4 | 1 |
| | g2 | 6380 | 0.46 | 24.1 | 1 |
| | h1 | 7680 | 0.55 | 21.6 | 1 |
| | h2 | 6758 | 0.48 | 24 | 1 |
| | i1 | 7394 | 0.53 | 21.6 | 1 |
| | i2 | 7434 | 0.53 | 19.9 | 1 |
| | j1 | 7307 | 0.52 | 22.4 | 1 |
| 6 | a1 | 7620 | 0.55 | 20.7 | 1 |
| | b1 | 6205 | 0.45 | 23.2 | 1 |
| | b2 | 7190 | 0.52 | 20.7 | 1 |
| | c1 | 6411 | 0.46 | 21.2 | 1 |
| | c2 | 7634 | 0.55 | 19.2 | 1 |
| | d1 | 7149 | 0.51 | 19.9 | 1 |
| | d2 | 6986 | 0.50 | 22.4 | 1 |
| | e1 | 7544 | 0.54 | 22.1 | 1 |
| | e2 | 6611 | 0.47 | 22.2 | 1 |
| | f1 | 7015 | 0.50 | 20.1 | 1 |
| | f2 | 6945 | 0.50 | 21 | 1 |
| | g1 | 6844 | 0.49 | 21.1 | 1 |
| | g2 | 6983 | 0.50 | 17.4 | 1 |
| | h1 | 7740 | 0.56 | 21.1 | 1 |
| | h2 | 6294 | 0.45 | 22.5 | 1 |
| | i1 | 7660 | 0.55 | 18.3 | 1 |
| | i2 | 7409 | 0.53 | 20.9 | 1 |
| | j1 | 6428 | 0.46 | 22.9 | 1 |

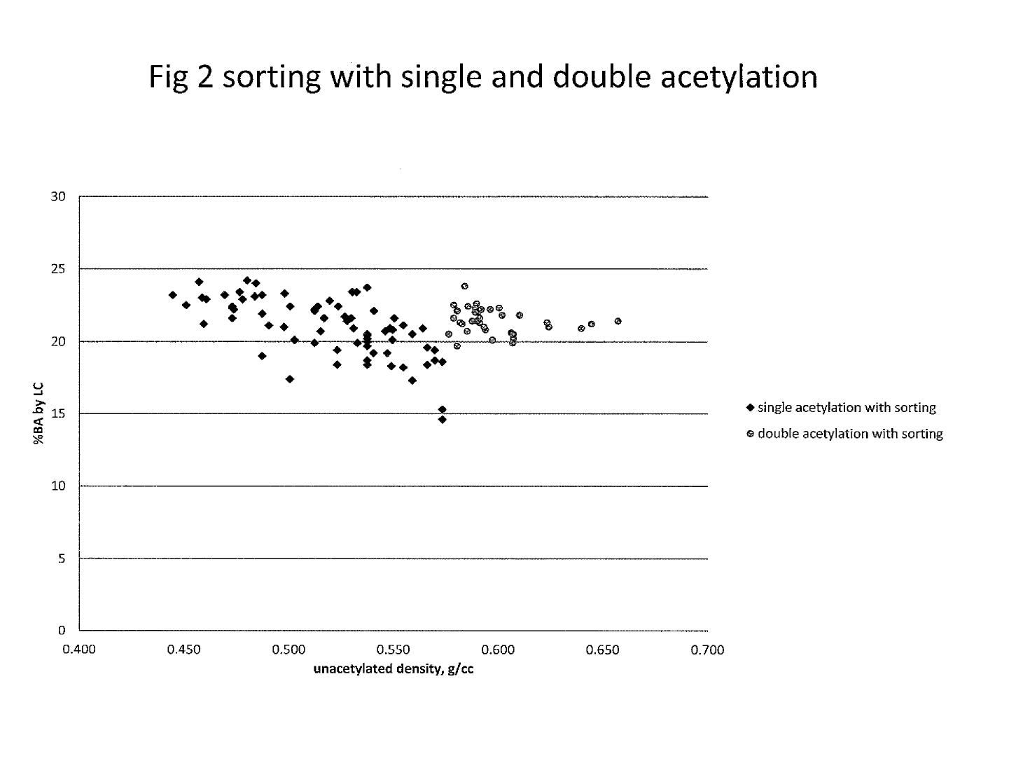

The data from Table 2 is further depicted graphically in FIG. 2. Diamond-shaped datapoints represent boards in the low-density group that were subjected to a single acetylation cycle. Round datapoints represent boards in the high-density group that were subjected to two acetylation cycles. As can be seen, the percent bound acetyls are much more consistent as density increases. This method allows consistent degree of acetylation without subjecting lower density boards to an unnecessary second acetylation.

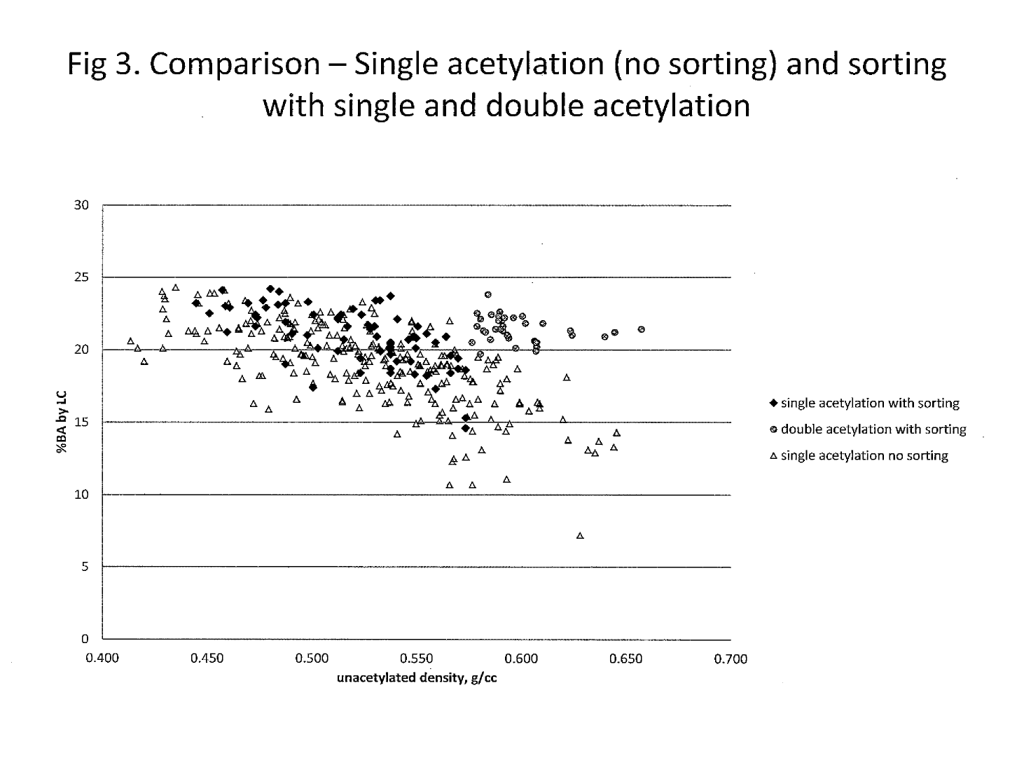

FIG. 3 combines the single acetylation data without density sorting from FIG. 1 with the sorted data in FIG. 2. Triangle-shaped datapoints represent single acetylation data without sorting by density. Other datapoints are as depicted in FIG. 2.

For double acetylation batch No. 1, the total cycle time, including drying was 14 hours and 35 minutes. The total drying time (after flash) was 5 hours and 50 minutes. For double acetylation batch No. 4, the total cycle time, including drying was 15 hours and 20 minutes. The total drying time (after flash) was 5 hours and 20 minutes. Variation in drying time is due to variation in the time necessary to reduce the pressure to 75-80 mmHg immediately after the flash as well as in the time being required to heat the boards to the 150-155 degree C range.

### Example 2

Eighteen 12′×5.5 inch×1 inch boards of Southern Yellow Pine were cut into two sections, each approximately 6′ long. One section of each board was placed in the reactor (with the 6 feet by 5.5 inch surface facing upwards) and separated from each other vertically by a rack that separated the boards by 0.5 inches and distributed free flow of gasses in the reactor across the faces of the boards. The boards had been kiln dried using a procedure that resulted in an average water content of the boards of 6%, as measured by the Delmhurst meter describe above, based on a random sampling of approximately 5% of the kiln charge. No boards were higher than 8% water content. Sensitivity calculations confirmed that the potential variability in % water content would not make a significant difference in the bone dry density calculated using the measured “wet” weight and the average % water content. A thermocouple was inserted into a pre-drilled hole in the side of the bottom of up to 6 boards at a location approximately two feet from the end of the board.

Boards were subjected to two acetylation cycles as follows. The reaction vessel pressure was reduced to <70 mm Hg using a steam jet and held between 53 and 67 mm Hg for 10 minutes. With continued vacuum, acetic anhydride (>95% acetic anhydride; <5% acetic acid) was added to fill the reactor such that the boards were completely submerged in acetic anhydride liquid. The reaction vessel pressure was then increased to 1800 mm Hg and held at that pressure for 25 minutes. Excess liquid (i.e. not absorbed into the boards) was drained from the vessel and then the pressure was reduced to 1200 mm Hg.

Heating of the oil jacket was then commenced. Hot vapors were generated by boiling a liquid containing approximately 95% acetic acid and 5% acetic anhydride in a steam jacketed pipe (nominal 100 psig steam pressure) and introducing the vapors into the reactor to deliver heat to the boards. Vapor delivery was through a vapor port located approximately in the center of the length of the boards on the top of the vessel. The flow of vapor continued for 60 minutes with the pressure held at 1200 mmHg. After the flow of vapor was discontinued, the vessel pressure during the acetylation was held at 1200 mm Hg for an additional 30 minutes. Any liquid that condensed in the bottom of the reactor during this period was evacuated using the vessel pressure to move the liquid to a separate atmospheric tank.

The pressure was then reduced to a target set point of 500 mmHg (actual pressure was 440-515 mmHg) for 20 minutes and this vacuum was held while a second charge of 95% acetic anhydride/5% acetic acid liquid was added. The reactor was then pressurized to 2100-2200 mm Hg and held for 15 minutes before the liquid was drained. After draining, pressure was held at 1800 mmHg while the additional hot vapors having the same composition as those used in the first cycle were added. Vapor flow was held until either the vent line temperature spiked above 40 degrees C. or for 80 minutes, whichever occurred first. Pressure was then increased to 2000 mmHg and held for 60 minutes. The pressure in the reaction vessel was then vented and then reduced further with the vacuum jet to a prescribed level between 75-80 mmHg and held for 15 minutes. The boards were then subjected to further processing to evaporate further the acetylation byproducts and any other liquids remaining in the boards.

Percent bound acetyl (% BA) along with weight and dry density numbers are shown below.

TABLE 3

| Board | wt (g) | Dry Density* | % BA |
|---|---|---|---|
| 122A1 | 4210 | 0.59 | 19.8 |
| 122B1 | 4330 | 0.60 | 21.1 |
| 122B2 | 4330 | 0.61 | 20.9 |
| 122C1 | 4030 | 0.57 | 20.8 |
| 122C2 | 4210 | 0.62 | 20.0 |
| 122D1 | 3980 | 0.57 | 20.9 |
| 122D2 | 3980 | 0.59 | 20.0 |
| 122E1 | 4190 | 0.59 | 20.9 |
| 122E2 | 4110 | 0.59 | 21.8 |
| 122F1 | 4070 | 0.58 | 20.6 |
| 122F2 | 4060 | 0.60 | 22.4 |
| 122G1 | 4410 | 0.61 | 22.8 |
| 122G2 | 4070 | 0.58 | 21.4 |
| 122H1 | 3840 | 0.58 | 23.0 |
| 122H2 | 4170 | 0.59 | 20.4 |
| 122I1 | 4240 | 0.61 | 20.5 |
| 122I2 | 4270 | 0.49 | 21.6 |
| 122J1 | 4890 | 0.71 | 17.2 |

*Density was calculated based on the original weight and dimensions of the 12′ long board before cutting. Weights shown are for the approximately 6 foot long section used in this experiment

Impregnation amount was determined for each acetylation cycle on a batchwise basis using the following equation (grams of impregnating liquid fed to the reactor for impregnation minus grams of impregnating liquid drained from the reactor after impregnation)/gram dry wood. The impregnation amount in the first acetylation cycle was 1.10 grams of impregnating liquid per gram of dry wood. The impregnation amount in the second acetylation cycle was only 0.84 grams of impregnating liquid per gram of dry wood.

Total time for the batch, including drying, was 11 hours 10 minutes. Drying time (after flash) was four hours and five minutes. Reduction in drying time is due to less time being necessary to reduce the pressure to 75-80 mmHg immediately after the flash, less time being required to heat the boards to the 150-155 degree C. range, or both. Reduction in the overall cycle time resulted from the foregoing factors as well as different acetylation cycle protocols. Each of these could result from less impregnant and byproduct being in the boards during the second batch. Thus, both the total batch time and drying time were reduced significantly while attaining favorable acetylation levels with higher density wood.

The inventors hereby state their intent to rely on the Doctrine of Equivalents to determine and assess the reasonably fair scope of the present invention as pertains to any method not materially departing from but outside the literal scope of the invention as set forth in the following claims.

What is claimed is:

1. A process for producing acetylated solid wood, the process comprising:
(a) determining a threshold value for a density-indicating parameter for a plurality of solid wood pieces;
(b) measuring an actual value for the density-indicating parameter for at least some of the solid wood pieces;
(c) identifying a low-density group of the solid wood pieces and a high-density group of the solid wood pieces based on the threshold value and the measured actual values for the density-indicating parameters; and
(d) subjecting at least a first majority selected from the high-density group of the solid wood pieces to at least one more acetylation cycle than at least a second majority selected from the low density group of the solid wood pieces.

2. The process of claim 1, wherein identifying the low-density group and the high-density group includes assigning to the high density group all boards for which the measured density-indicating parameter indicates a density that is greater than that indicated by the threshold value, and assigning to the low density group all boards for which the measured density-indicating parameter indicates a density that is less than or equal to that indicated by the threshold value.

3. The process of claim 1, wherein identifying the low-density group and the high-density group includes assigning to the high density group all boards for which the measured density-indicating parameter indicates a density that is greater than or equal to that indicated by the threshold value, and assigning to the low density group all boards for which the measured density-indicating parameter indicates a density that is less than that indicated by the threshold value.

4. The process of claim 1, wherein the threshold value and actual values for density-indicating parameter measurements indicate dry density.

5. The process of any of claim 1, wherein the actual values for the density-indicating parameter measurements indicate wet density, the method further comprises identifying water content of the at least some pieces, and the threshold value is a wet density value that, based on the identified water content, corresponds to a selected dry density value.

6. The process of claim 1, wherein at least one of the acetylation cycles for the high-density group is less robust than at least one of the acetylation cycles for the low-density group.

7. The process of claim 1, wherein at least one of the acetylation cycles for the high-density group is less robust than all of the acetylation cycles for the low-density group.

8. The process of claim 1, wherein all of the acetylation cycles for the high-density group are less robust than all of the acetylation cycles for the low-density group.

9. The process of claim 1, wherein at least one of the acetylation cycles for the high-density group is less robust than at least one of the other acetylation cycles for the high-density group.

10. The process of claim 9, wherein the sequentially final acetylation cycle for the high-density group is more robust than at least one other acetylation cycle for the high-density group.

11. The process of claim 1 wherein measuring an actual value for the density-indicating parameter comprises measuring actual density.

12. The process of claim 1 wherein measuring an actual value for the density-indicating parameter comprises measuring a mass value that determines density based on the dimensions of solid wood pieces.

13. The process of claim 1 wherein the threshold value is a value that indicates a density between about 0.52 and about 0.63 g/cc.

14. The process of claim 1 wherein the threshold value is a value that indicates a density that corresponds to a dry density of 0.57 g/cc on a 95/5 impregnant and 6% wood water basis.

15. The process of claim 1 wherein the solid wood is southern yellow pine.

16. The process of claim 1 wherein at least the first majority of the solid wood pieces in the high density group are subjected to two acetylation cycles and at least the second majority of the solid wood pieces in the low density group are subjected to one acetylation cycle.

17. The process of claim 1 wherein the first majority comprises a majority of the total number of pieces in the high-density group and the second majority comprises of the total number of solid wood pieces in the low-density group.

18. The process of claim 17, wherein the first majority comprises at least about 90% of the total number of solid wood pieces in the high-density group the second majority comprises at least about 90% of the total number of the solid wood pieces in the low-density group.

19. The process of claim 17 wherein the first majority comprises all solid wood pieces of the high-density group and the second majority comprises all solid wood pieces of the low-density group.

20. The process of claim 1 wherein the process comprises further screening and removal of solid wood pieces based on nonconformity with a specification and the first majority is a majority of the on-specification solid wood pieces of the high density group and the second majority is a majority of the on-specification solid wood pieces of the low-density group.

21. The process of claim 20, wherein the first majority comprises at least about 90% of the on-specification solid wood pieces in the high-density group the second majority comprises at least about 90% of the on-specification solid wood pieces in the low-density group.

22. The process of claim 20 wherein the first majority comprises all on-specification solid wood pieces of the high-density group and the second majority comprises all the on-specification solid wood pieces of the low-density group.

23. The process of claim 1 wherein the total mass uptake of impregnating fluid of all impregnation steps in the process is from about 0.80 to about 2.00 grams of impregnating fluid per gram of wood.

24. A process for producing acetylated solid wood, the process comprising acetylating solid wood using two or more acetylation cycles to thereby produce acetylated wood, wherein at least one of the two or more acetylation cycles is less robust than at least one other of the two or more acetylation cycles, at least one of the two or more acetylation cycles includes an impregnation step that is less robust than the impregnation step at least one other of the two or more acetylation cycles, or both of the foregoing.

25. The process of claim 24, wherein at least one of the two or more acetylation cycles is less robust than at least one other of the two or more acetylation cycles

26. The process of claim 25, wherein the sequentially first acetylation cycle is less robust than at least one other acetylation cycle.

27. The process of claim 25, wherein the sequentially last acetylation cycle is more robust than at least one other acetylation cycle.

28. The process of claim 25, wherein the sequentially first acetylation cycle is more robust than at least one other acetylation cycle.

29. The process of claim 25, wherein the sequentially last acetylation cycle is less robust than at least one other acetylation cycle.

30. The process of claim 25, wherein the total number of acetylation cycles in the process is two.

31. The process claim 25, wherein at least one of the two or more acetylation cycles includes an impregnation step that is less robust than the impregnation step of at least one other of the two or more acetylation cycles.

32. The process of claim 31, wherein the less robust impregnation step has a mass uptake of impregnating fluid that is from about 0.05 to about 0.50 fewer grams of impregnating fluid per gram of wood than the mass uptake of impregnating fluid of the more robust cycles

33. The process of claim 24 wherein the total mass uptake of impregnating fluid of all impregnation steps in the process is from about 0.80 to about 2.00 grams of impregnating fluid per gram of wood.

34. The process of claim 24, wherein the solid wood is southern yellow pine.
